(19) United States
(12) Patent Application Publication
(10) Pub. No.: US 2026/0214012 A1
(43) Pub. Date: Jul. 23, 2026

(54) A MANAGEMENT DATA ANALYTIC PRODUCER FOR ANALYTICAL ASSURANCE CLOSED CONTROL LOOP MANAGEMENT AND A METHOD THEREOF

(71) Applicant: Samsung Electronics Co., Ltd., Suwon-si, Gyeonggi-do (KR)

(72) Inventors: Deepanshu GAUTAM, Bangalore (IN); Ashutosh KAUSHIK, Bangalore (IN)

(21) Appl. No.: 19/133,504

(22) PCT Filed: Dec. 29, 2023
(86) PCT No.: PCT/KR2023/022023

§ 371 Date: May 28, 2025

(30) Foreign Application Priority Data
Jan. 2, 2023 (IN) 202341000118
Dec. 5, 2023 (IN) 2023 41000118

(51) Int. Cl. H04L 41/14; H04L 41/34

(52) U.S. Cl. CPC H04L 41/14; H04L 41/34

(57) ABSTRACT

The disclosure relates to a 5G or 6G communication system for supporting a higher data transmission rate. A method performed by a management data analytics (MDA) consumer in a wireless communication system, the method, comprising identifying a filter associated with a list of distinguished names (DNs) indicating at least one no recommendation should be given, transmitting, to a MDA producer, a request message including the filter, and receiving, from the MDA producer, as a response to the request message, a report message including at least one recommendation identified based on the filter.

### TECHNICAL FIELD

The present disclosure relates to a field of assurance closed control loop and management data analytics. More particularly, the present disclosure relates to a Management Data Analytic (MDA) producer for analytical assurance closed control loop management and a method thereof.

### BACKGROUND ART

5G mobile communication technologies define broad frequency bands such that high transmission rates and new services are possible, and can be implemented not only in “Sub 6 GHz” bands such as 3.5GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mm Wave, supporting numerologies (for example, operating multiple subcarrier spacings) for efficiently utilizing mm Wave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is un-available, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial In-telligence) from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE OF INVENTION

### Technical Problem

This disclosure relates to apparatuses and methods for supporting management data analytic procedure for analytical assurance closed control loop management and a method.

### Solution to Problem

The foregoing summary is illustrative only and is not intended to be in any way limiting. In addition to the illustrative aspects, embodiments, and features described above, further aspects, embodiments, and features will become apparent by reference to the drawings and the following detailed description.

In an embodiment, a method for Assurance Closed Control Loop (ACCL) management is disclosed. The method includes receiving, by a Management Data Analytics (MDA) producer associated with a Network Function (NF), a MDARequest comprising one or more attributes from a MDA consumer. The one or more attributes comprise at least one disallowed Management Object Instance (MOI). The method includes generating, by the MDA producer, an analytic report based on the one or more attributes.

In an embodiment, a MDA producer for Assurance Closed Control Loop (ACCL) management is disclosed. The MDA producer includes a memory configured to store instructions. The MDA producer includes a processor configured to execute the instructions stored in the memory and thereby configured to receive a MDARequest comprising one or more attributes from a MDA consumer. The one or more attributes comprises at least one disallowed MOI. The processor is configured to generate an analytic report based on the one or more attributes.

The foregoing summary is illustrative only and is not intended to be in any way limiting. In addition to the illustrative aspects, embodiments, and features described above, further aspects, embodiments, and features will become apparent by reference to the drawings and the following detailed description.

### Advantageous Effects of Invention

According to an embodiment of the disclosure, a management data analytic procedure for analytical assurance closed control loop management can be performed efficiently.

### BRIEF DESCRIPTION OF DRAWINGS

The accompanying drawings, which are incorporated in and constitute a part of this disclosure, illustrate exemplary embodiments and, together with the description, serve to explain the disclosed principles. The same numbers are used throughout the figures to reference like features and components. Some embodiments of at least one of device and methods in accordance with embodiments of the present subject matter are now described, by way of example only, and with reference to the accompanying figures, in which:

FIG. 1 illustrates an environment in which some embodiments of the present disclosure may be practiced;

FIG. 2 illustrates a MDA producer for Assurance Closed Control Loop (ACCL) management, in accordance with an embodiment of the present disclosure;

FIG. 3 illustrates a flow chart of a method for configuration of an analyticsScope attribute in a MDA producer, in accordance with an embodiment of the present disclosure;

FIG. 4 illustrates a sequence flow of a method for ACCL management, in accordance with an embodiment of the present disclosure; and

FIG. 5 illustrates a flow chart of a method for ACCL management, in accordance with an embodiment of the present disclosure.

The figures depict embodiments of the disclosure for purposes of illustration only. One skilled in the art will readily recognize from the following description that alternative embodiments of the structures and methods illustrated herein may be employed without departing from the principles of the disclosure described herein.

### MODE OF INVENTION

Management Data Analytics (MDA) is a key enabler of automation and intelligence for mobile networks, service management and orchestration. Typically, a MDA producer processes and analyzes data related to network and service events and status, for example, performance measurements, Key Performance Indicators (KPIs), trace reports, Quality of Experience (QoE) reports, alarms, configuration data, network analytics data, and service experience data from Application Function (AFs) and the like to provide analytics output. More specifically, the analytics output includes, statistics, predictions, root cause analysis, issues and the like. Further, MDA may also include recommendations to enable necessary actions for network and service op-erations such as, scaling of resources, admission control, and the like. The analytics output is provided by the MDA producer to a consumer(s) (referred to hereinafter as ‘MDA consumer(s)’) that requested the analytics. In an example, the MDA producer for a Network Function (NF) may perform analytics on load related performance data such as resource usage of the NF. The MDA producer may identify ongoing issues impacting the performance of the network and help in identifying potential issues that may cause failure and/or performance degradation. The analytics output is provided to the MDA consumer by the MDA producer in an analytics report on request.

Conventionally, the MDA producer may recommend the MDA consumer to re-configure and/or modify one or more Management Object Instances (MOIs) for managing the load. However, the MDA consumer is not capable of reconfiguring and/or modifying all the MOIS. The MOIs that the MDA consumer is not capable of reconfiguring and/or modifying are referred to as disallowed MOIs and are part of a disallowed list. The MOIs may be part of the disallowed list for a plurality of reasons such as, the MOI may be reserved for a particular entity, capabilities of the MOIs are different from that of the MDA consumer, and the like. If the recommendations provided by the MDA producer includes the disallowed MOIs, the MDA consumer will fail to execute the recommendations. Hence, the MDA consumer will request a new recommendation until it receives a recommendation that can be executed. However, this process is tedious and time consuming due to repeated requests. Further, it reduces the performance of the MDA consumer until it receives an appropriate recommendation. Therefore, there is need for a method to improve the analytics report provided by the MDA producer.

The information disclosed in this background of the disclosure section is only for enhancement of understanding of the general background of the invention and should not be taken as an acknowledgement or any form of suggestion that this information forms the prior art already known to a person skilled in the art.

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternative falling within the spirit and the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a device or system or apparatus proceeded by “comprises ... a” does not, without more constraints, preclude the existence of other elements or additional elements in the device or system or apparatus.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

It shall be noted that embodiments of the present disclosure are explained with reference to an Assurance Closed Control Loop (ACCL) producer as a MDA consumer for exemplary purposes. However, it shall be noted that any other entity in the network may be the MDA consumer in communication with the MDA producer may utilize services of the MDA producer such as, but not limited to, Management Service Functions (MnFs) (i.e., MnS producers/consumers for network and service management), Network Functions (NFs) (e.g., 5G Network Data Analytics Function (NWDAF)), Self-Organizing Network (SON) functions, network and service optimization tools/functions, Service Level Specification (SLS) assurance functions, Application Functions (AFs) and the like, as depicted in the present invention.

The term “Assurance Closed Control Loop” used herein refers to a closed control loop with no direct involvement of a human operator and/or other management entity making it fully automated. The human operator and/or management entity is not directly controlling the details inside the ACCL but provides control outside the ACCL. For example, configuring goals for the ACCL to make autonomous decisions within the boundaries of the goal. Once the ACCL is configured with the goal, the ACCL is adjusted according to the set goals.

It may be noted that, for convenience of explanation, the disclosure uses terms and names defined in the 3rd Generation Partnership Project Radio Access Network (3GPP RAN) standards. More specifically, the terms MDA producer, MDA consumer, analytics report, taiList, areaScope, observationTime, MDARequest and the like are to be interpreted as specified by the relevant 3GPP standards.

A Closed Loop SLS Assurance (eCOSLA) work in 3rd Generation Partnership Project (3GPP) SA5 working group. The closed control loops are being defined where there is no direct involvement of a human operator or other management entity in the control loop, and the control loop is fully automated. The human operator or management entity is not directly controlling the details inside the process steps but provides control outside the loop. For example, configuring goals for the control loop to make autonomous decisions within the boundaries of the set goal. Once the control loop is configured with the goal, the controlled entity is adjusted according to the set goals. In a closed control loop the input to the control loop provided by human operator or other management entity may include the goal or policies. The output of the closed control loop may include closed control loop status to a human operator or other management entity. Typically, the goal is set within certain parameter boundaries, and the closed control loop can automatically monitor the network and ascertain if the defined goals are being breached. If the goal is determined to be breached, then the loop can re-configure the network to mitigate the breach.

A Management Data Analytics Service (MDAS) provides data analytics of different network related parameters including for example load level and/or resource utilisation. For example, the MDAS for a Network Function (NF) can collect the NF's load related performance data, e.g., resource usage status of the NF. The analysis of the collected data may provide forecast of resource usage information in a predefined future time. This analysis may also recommend appropriate actions e.g., scaling of resources, admission control, load balancing of traffic, etc. A MDAS for a Network Slice Subnet Instance (NSSI) provides NSSI related data analytics. The service may consume the corresponding MDAS of its constituent NFs'. The NSSI MDAS may further classify or shape the data in different useful categories and analyse them for different network slice subnet management needs (e.g., scaling, admission control of the constituent NFs etc.). If an NSSI is composed of multiple other NSSIs, the NSSI MDAS acts as a consumer of MDAS of the constituent NSSIs for further analysis e.g., resource usage prediction, failure prediction for an NSSI, etc. A MDAS for a Network Slice Instance (NSI) provides NSI related data analytics. The service may consume the corresponding MDAS of its constituent NSSI(s). The NSI MDAS may further classify or shape the data in different useful categories according to different customer needs, e.g., slice load, constituent NSSI load, communication service loads. This data can be used for further analysis e.g., resource usage prediction, failure prediction for an NSI, etc.

MDA represents Analytics roles in the ACCL for communications service assurance. The management and control of resources used by a communication service and the assurance of this communication service level agreements (e.g. per SLS) is provided by the ACCL involving different management services produced by the management system, which includes Management Data Analytics Service (MDAS, or MDA MnS). The MDAS (MDA MnS) may be produced based on a combination of information including e.g. the user quality of service experience, network performance and network resource utilization analysis and the SLS.

The MDAS complements other services in the management loop in order to perform SLS communication service assurance. Prior to operation phase, the MDA role in the ACCL is to prepare, process and analyse the data related to the managed communication service, in order to provide the analytics output (analytics report) which may include prediction and feasibility checks of network resource requirements to meet the SLS.

During the operation phase, the MDA can identify ongoing issues impacting the performance of the communication service per the SLS and identify in advance potential risks that would cause potential failure and/or performance degradation. The MDA can also predict the network and service demand to maintain delivery of communication service per the contracted SLS.

As per existing definitions, MDA is part of the analytics step of the assurance closed control loop (ACCL). That implies that the ACCL producer needs to interact with MDAS Producer in order to get the required analytics reports. The received analytics reports are utilized during the Analytics step of the ACCL. The ACCL Producer needs to instantiate MDARequest IOC at the runtime based on the instantiated Assurance-ClosedControlLoop IOC. Since, there is no human intervention in ACCL, there is a need for the following issues to be addressed:
1. How ACCL Producer will ensure that the recommendations provided in the report should not relate to the MOIs identified in the aCCLDisallowedList?
2. How ACCL Producer will decide on the analyticsScope of the analytics report it is asking for?
3. How ACCL Producer will decide what reports (MDAType and the MDAOutputs) are to be collected from the MDAS Producer?
4. How the observation Time is mapped with MDARequest attributes?

The present disclosure relates to a method and system for analytical assurance closed control loop management. The present disclosure includes defining logic to generate MDARequest based on configured ACCL. This includes the following:
1. An attribute recommendationFilter is defined as a part of MDARRequest specifying the list of nodes (identified by DN) and its attributes, the ACCL does not want to be included in the recommendations of the MDA report The recommendationFilter attribute gets its value from an attribute aCCLDisallowedList.
2. An attribute analyticsScope in MDARRequest is decided based on
a. Solution 1:
i. If AssuranceGoal contains sliceProfileId then the managedEntitiesScope should be set to the DN of related NetworkSliceSubnet.
ii. If AssuranceGoal contains serviceProfileId then the managedEntitiesScope should be set to the DN of related NetworkSlice.
iii. If both are present, then the managedEntitiesScope should be set to the DN of both NetworkSlice and NetworkSliceSubnet.
b. Solution 2:
i. A new attribute is to be added, in the MDARequest IOC, to set the areaScope with a geographical location (defined as one of TaiList, a set of latitude and longitude or a civic address) coming from the assuranceScope attributes of AssuranceGoal IOC. Or a new Choice_3 is to be added for AnalyticsScopeType to represent a geographical location (defined as one of TaiList, a set of latitude and longitude or a civic address).
3. Deciding on the attribute requestedMDAOutputs in MDARequest:

An attribute mDAType may be populated with all reports under SLS analysis category of MDAS as defined in 3GPP TS 28.104. The attribute mDAOutputIEFilters will be absent, indicating that all the output defined needs to be returned as part of the respective reports.
4. Deciding on the startTime/stopTime attribute in MDARequest

An attribute startTime and stopTime may get their values from the attribute observation Time in AssuranceGoal.

Thus, in the present disclosure, the ACCL Producer may interact with MDAS Producer without any human intervention. Also, the ACCL Producer will be able to generate MDARequest at runtime considering the configuration done for a particular ACCL. The ACCL Producer may receive MDA recommendations only for those entities that it can modify/re-configure. Furthermore, the ACCL Producer may restrict the MDA analytics scope to entities in a particular geographical location. The geographical location can be defined as one of TaiList, a set of latitude and longitude or a civic address.

In an embodiment of the present disclosure, a procedural flow between ACCL Producer and MDAS producer for analytical assurance closed loop management is explained.

In an embodiment, the ACCL producer may interact with the MDAS producer to request for the analysis report. The ACCL may use the report to monitor, measure and assess real-time traffic in the communication network and may automatically optimize end-user Quality of Experience (QoE) for enhanced network experience by the end-users. In the present disclosure, the interaction between the ACCL producer and the MDAS producer includes several steps as described below:

Initially, at step 1, the ACCL producer may configure an ACCL based on the mechanism defined in 3GPP TS 28.536.

At step 2, upon the configuration, the ACCL producer during running of Analysis phase, request MDAS producer for the analytics report. The ACCL producer create MDARequest based on the information configured as part of ACCL NRM as defined in 3GPP TS 28.536. The ACCL producer may generate MDARRequest by specifying several attributes based on the configuration information. The one or more attributes specified in the MDARRequest may include:
a. Providing an attribute, in addition to the attributes already defined as part of MDARequest, defining the list of nodes (identified by DN), the ACCL does not want to be included in the recommendations of the MDA report. This attribute gets its value from the attribute aCCLDisallowedList.
b. The attribute analyticsScope get populated as follows:
i. If AssuranceGoal contains sliceProfileId then the managedEntitiesScope should be set to the DN of related NetworkSliceSubnet. If AssuranceGoal contains serviceProfileId then the managedEntitiesScope should be set to the DN of related NetworkSlice. If both are present, then the managedEntitiesScope should be set to the DN of both NetworkSlice and NetworkSliceSubnet. Or,
ii. The areaScope attribute is set with the particular geographical location, defined as one of TaiList, a set of latitude and longitude or a civic address, coming from the assuranceScope attributes of AssuranceGoal IOC.
c. The attribute mDAType is populated with will the report under SLS analysis category of MDAS as defined in 3GPP TS 28.104. The attribute mDAOutputIEFilters will be absent, indicating that all the output defined needs to be returned as part of the respective reports.
d. The startTime and stopTime attributes will get their values from the attribute observation Time in AssuranceGoal.

At step 3, upon creation of MDARequest, the ACCL producer sends createMOI(MDARequest (recommendation filter, geolocation)) request as per the attributes decided in the step 2, to the MDAS producer.

At step 4, the ACCL producer may subscribe for receiving MDA reports as per the mechanism defined in 3GPP TS 28.104.

At step 5, upon receiving the MDARRequest, MDAS producer may perform the analysis and generates MDA reports as requested.

At step 6, the MDAS producer may send the generated MDA report to the ACCL producer as per the mechanism defined in 3GPP TS 28.104.

At step 7, upon receiving the MDA report, the ACCL producer may utilize the MDA report during the analysis phase.

The ACCL producer may use the MDA report to monitor, measure and assess real-time traffic in the communication network and may automatically optimize end-user Quality of Experience (QoE) for enhanced network experience by the end-users.

In an embodiment the result of the above steps, enables:
The ACCL Producer to interact with MDAS Producer without any human intervention. The ACCL Producer will be able to generate MDARequest at runtime considering the configuration done for a particular ACCL.

The ACCL Producer to receive MDA recommendations only for those entities that it can modify/re-configure.
The ACCL Producer to restrict the MDA analytics scope to entities in a particular TaiList.

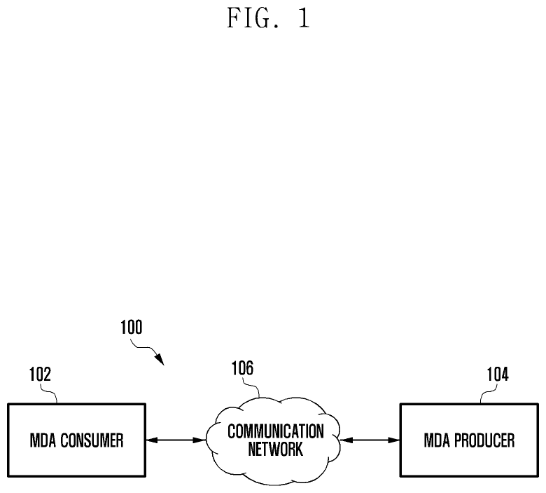

Various embodiments of the present disclosure are hereinafter explained with reference to FIGS. 1-5.

FIG. 1 illustrates an environment 100 in which some embodiments of the present disclosure may be practiced. The environment 100 exemplarily depicts an MDA consumer 102. Some examples of the MDA consumer 102 may include, but are not limited to, ACCL, Management Service Functions (MnFs) (i.e., MnS producers/consumers for network and service management), Network Functions (NFs) (e.g., 5G Network Data Analytics Function (NWDAF)), Self-Organizing Network (SON) functions, network and service optimization tools/functions, Service Level Specification (SLS) assurance functions, human operators, Application Functions (AFs) and the like. Embodiments of the present disclosure are hereinafter explained with reference to ACCL producer as the MDA consumer 102.

The MDA consumer 102 comprises four steps of operation: monitor, analyze, decide and execute. The MDA consumer 102 monitors various data such as performance measurements, alarms, trace, Quality of Experience (QoE) data, and the like. The data is then analyzed by sending a MDARequest to MDA producer 104 via a communication network 106. The MDA consumer 102 and the MDA producer 104 may connect to the communication network 106 using a wired network, a wireless network, or a combination of wired and wireless networks. Some non-limiting examples of the wired networks may include the Ethernet, the Local Area Network (LAN), a fiber-optic network, and the like. Some non-limiting examples of the wireless networks may include the Wireless LAN (WLAN), cellular networks, Bluetooth or ZigBee networks, and the like. An example of the communication network is the Internet.

The MDARequest may be sent to the MDA producer 104 based on a configuration of the MDA consumer 102. More specifically, the MDA consumer 104 may be configured to send the MDARequest periodically, triggered in response to an event, based on a subscription for receiving analytics reports as per the mechanism defined in 3GPP TS 28.104. or in response to a command by an operator. The MDA consumer 102 is configured based on an assurance goal (hereinafter interchangeably referred to as ‘goal’) refers to the goals that may be provided by a human operator or any other management entity for the MDA consumer 102. The assurance goal is provided while configuring the MDA consumer 102. The assurance goal is set to eliminate the need for the human operator or any other management entity to monitor the MDA consumer 102. For example, the goals of the MDA consumer 102 are configured such that the MDA consumer 102 can make autonomous decisions within the boundaries of the set goal. Once the MDA consumer 102 is configured with the goal, the MDA consumer 102 can be adjusted automatically according to the set goals without any external intervention. Typically, the goal is set within certain parameter boundaries, and the MDA consumer 102 can automatically monitor the network and ascertain if the defined goals are being breached. If the goal is determined to be breached, then the MDA consumer 102 can re-configure the network to mitigate the breach.

The MDA producer 104 will analyze the data provided by the MDA consumer 102 and send an analytic report to the MDA consumer 102. Typically, the analytic report includes one or more recommendations related to one or more network parameters. The one or more network parameters may include but is not limited to throughput, energy, traffic, Service Level Specification (SLS), load and the like. The MDA consumer 102 will decide which recommendation provided in the analytic report should be implemented. Accordingly, the MDA consumer 102 executes recommendations provided by the MDA producer 104 to improve various network parameters.

For example, if the load requirements of the MDA consumer 102 is more than that of allocated resources, the MDA producer 104 may provide one or more recommendations to manage the load requirements. The one or more recommendations may include solutions to overcome the failures caused due to inadequate resources thereby effectively managing resources. For example, the MDA producer 104 may recommend one or more Management Object Instances (MOIs) that can be reconfigured to accommodate the load requirements. Some examples of the MOIs may include, but are not limited to router, switch, server, base stations, and the like.

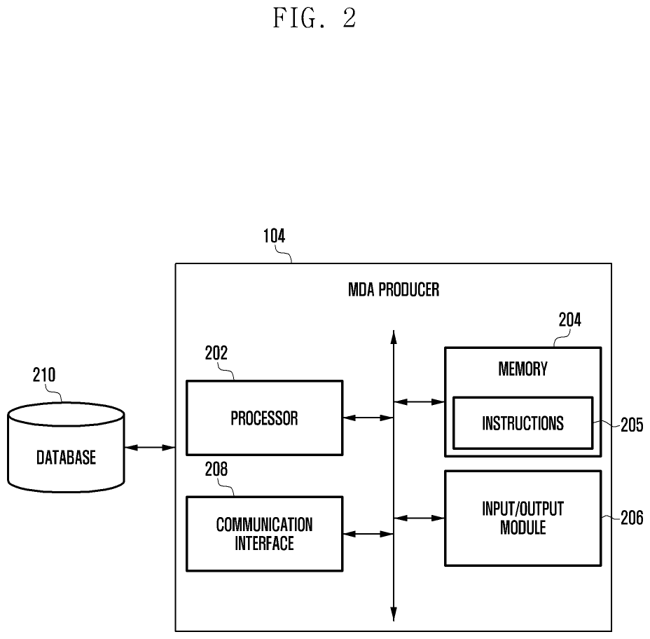

Various embodiments of the present disclosure disclose a method performed by the MDA producer 104 for generating the analytic report for the MDA consumer 102. More specifically, the MDA consumer 102 sends a MDARequest comprising one or more attributes to the MDA producer 104. The one or more attributes may include, but is not limited to, a recommendationFilter, a startTime, a stopTime, an areaScope and the like. The MDA producer 104 generates an analytics report based on the one or more attributes. The operations performed by the MDA producer 104 are explained in detail next with reference to FIG. 2.

FIG. 2 illustrates the MDA producer 104 for Assurance Closed Control Loop (ACCL) management, in accordance with an embodiment of the present disclosure. As already explained, the MDA producer 104 is configured to the generate analytics report comprising one or more recommendations for MOI's.

The MDA producer 104 is depicted to include a processor 202, a memory 204, an Input/Output (I/O) module 206, and a communication interface 208. It may be noted that, in some embodiments, the MDA producer 104 may include more or fewer components than those depicted herein. The various components of the MDA producer 104 may be implemented using hardware, software, firmware or any combinations thereof. Further, the various components of the MDA producer 104 may be operably coupled with each other. More specifically, various components of the MDA producer 104 may be capable of communicating with each other using communication channel media (such as buses, interconnects, etc.).

In one embodiment, the processor 202 may be embodied as a multi-core processor, a single core processor, or a combination of one or more multi-core processors and one or more single core processors. For example, the processor 202 may be embodied as one or more of various processing devices, such as a coprocessor, a microprocessor, a controller, a digital signal processor (DSP), a processing circuitry with or without an accompanying DSP, or various other processing devices including, a microcontroller unit (MCU), a hardware accelerator, a special-purpose computer chip, or the like.

In one embodiment, the memory 204 is capable of storing machine executable instructions 205, referred to herein as instructions 205. In an embodiment, the processor 202 is embodied as an executor of software instructions. As such, the processor 202 is capable of executing the instructions 205 stored in the memory 204 to perform one or more operations described herein.

The memory 204 can be any type of storage accessible to the processor 202 to perform respective functionalities. For example, the memory 204 may include one or more volatile or non-volatile memories, or a combination thereof. For example, the memory 204 may be embodied as semiconductor memories, such as flash memory, mask ROM, PROM (programmable ROM), EPROM (erasable PROM), RAM (random access memory), etc. and the like.

In an embodiment, the processor 202 is configured to execute the instructions 205 to: (1) receive a MDARequest comprising one or more attributes from a MDA consumer 102, (2) identify one or more allowed MOIs from a plurality of MOIs excluding the at least one disallowed MOI, (3) determine one or more recommendations for the one or more allowed MOIs, and (4) generate an analytic report based on the one or more attributes.

In an embodiment, the I/O module 206 may include mechanisms configured to receive inputs from and provide outputs to an operator of the MDA producer 104 (not shown in FIGS). The term ‘operator of the MDA producer 104’ as used herein may refer to one or more individuals whether directly or indirectly, associated with managing the MDA producer 104. To enable reception of inputs and provide outputs to the MDA producer 104, the I/O module 206 may include at least one input interface and at least one output interface. In an example, the operator of the MDA producer 104 may configure the MDA producer 104 via the at least one input interface. Examples of the input interface may include, but are not limited to, a keyboard, a mouse, a joystick, a keypad, a touch screen, soft keys, a microphone, and the like. Examples of the output interface may include, but are not limited to, a display such as a light emitting diode display, a thin-film transistor (TFT) display, a liquid crystal display, an active-matrix organic light-emitting diode (AMOLED) display, a microphone, a speaker, a ringer, and the like.

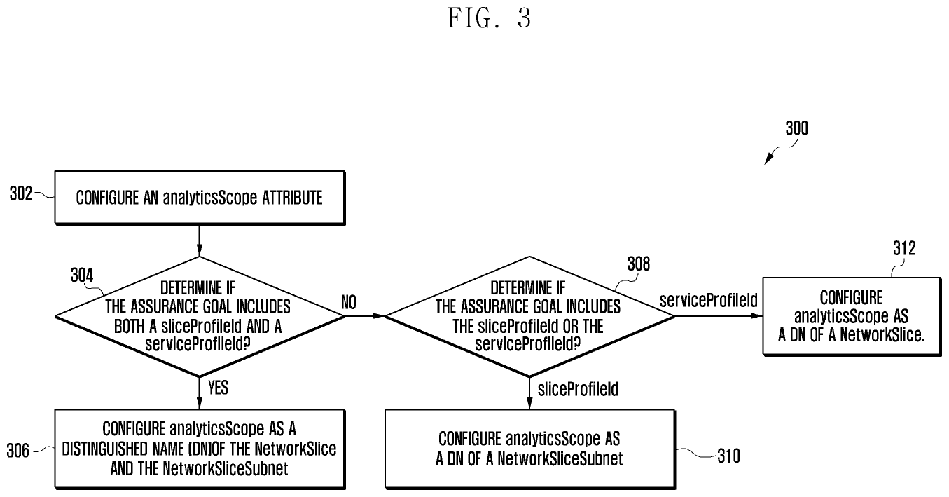

In an embodiment, the communication interface 208 may include mechanisms configured to communicate with other entities in the environment 100, for example, the MDA consumer 102. In an embodiment, the communication interface 208 of the MDA producer 104 receives the MDARequest from the MDA consumer 102 and sends the analytic report in response. The MDARequest comprises one or more attributes. The one or more attributes may include, but not limited to, a recommendationFilter, a startTime, a stopTime, an areaScope and the like. In an embodiment, the one or more attributes are configured based on a configuration of the MDA consumer 102. The recommendationFilter gets its value based on a disallowed list specified by the MDA consumer 102. As such, the disallowed list comprises information related to the at least one disallowed MOI that the MDA consumer 102 is not capable of reconfiguring and/or modifying. The areaScope is set with one of a Tracking Area Identity List (TaiList), a set of latitude and longitude values and a civic address. The startTime and the stopTime gets its value from observationTime defined in the assurance goal. Configuration of the analyticsScope by the MDA consumer 102 is explained with reference to FIG. 3.

FIG. 3. illustrates a flow chart of a method 300 for configuration of analyticsScope attribute, in accordance with an embodiment of the present disclosure. The analyticsScope is an attribute which is configured based on a configuration of the MDA consumer 102. The parameters pertaining to the configuration of the MDA consumer 102 and the MDA producer 104 are disclosed in 3GPP release TS 128 104 and are not explained herein for the sake of brevity.

At 302, configuration of the analyticScope attribute is initiated. The analyticsScope attribute is configured based on an assurance goal. The assurance goal comprises an assuranceScope which defines the scope of the analytics to be performed by the MDA producer 104.

At 304 the MDA consumer 102 determines if the assurance goal includes a sliceProfileId and a serviceProfileId. The sliceProfileId is an identification of a network slice. The sliceProfileId is indicated by a Non-Access Stratum (NAS) information element called Network Slice Selection Assistance Information (NSSAI). The service-ProfileIddefines services that can be accessed by the Management Object Instance (MOI) associated with the serviceProfileId. If the assurance goal includes to both the sliceProfileId and the serviceProfileId, then step 306 is performed else step 308 is performed.

At 306, the analyticScope is set to a Distinguished Name (DN) of both NetworkSliceSubnet and NetworkSlice.

At 308, the MDA consumer 102 determines if the assurance goal includes a sliceProfileId or a serviceProfileId. If the assurance goal includes the sliceProfileId, then step 310 is performed else step 312 is performed. At 310, the analyticsScope is set to a Distinguished Name (DN) of a NetworkSliceSubnet when the assurance goal includes a sliceProfileId composed of Network Functions (NFs). The NetworkSliceSubnet represents management aspects of a set of NFs thereby providing information about management of resources of the network slice to the MDA producer 104. This helps in defining the scope of the analysis performed by the MDA producer 104.

At 312 the assurance goal is set to a NetworkSlice when the assurance goal includes a serviceProfileId. When the assurance goal is set to the serviceProfileId, the analyticsScope is set to a DN of a NetworkSlice. The NetworkSlice is an independent virtualized instance that defines the allocation of a subnet of available resources. This helps in defining the scope of the analysis performed by the MDA producer 104.

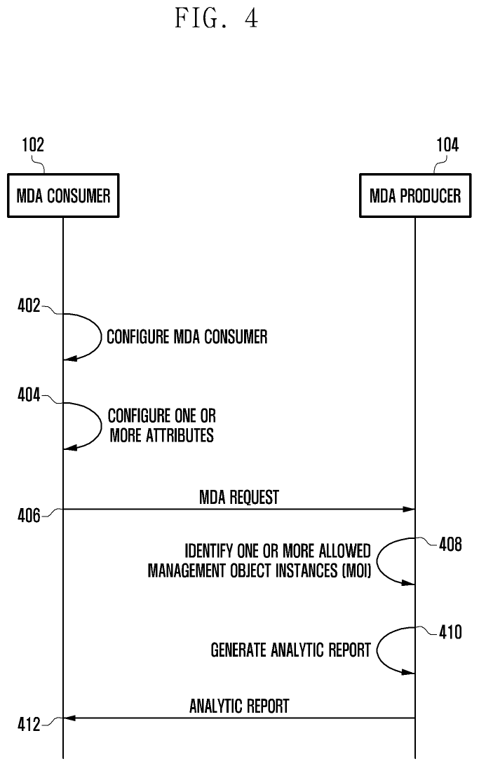

Referring back to FIG. 2, the communication interface 208 forwards the MDARequest to the processor 202. The processor 202 in conjunction with the instructions 205 in the memory 204 is configured to process the one or more attributes in the MDARequest to generate an analytic report. The processing of the MDARequest and generating the analytic report has been explained next in detail with reference to FIG. 4.

FIG. 4 illustrates sequence flow of a method 400 for Assurance Closed Control Loop (ACCL) management, in accordance with an embodiment of the present disclosure.

At 402, an MDA consumer 102 is configured. A configuration of the MDA consumer 102 may be based on a network configuration, a goal set by a human operator, a goal set by a management entity, and the like. The configuration of the MDA consumer 102 is explained in detail in 3GPP release TS 28 104.

At 404, one or more attributes are obtained as part of the MDARequest sent by the MDA consumer 102. The one or more attributes may include, but not limited to, a recommendationFilter, a startTime, a stopTime, an areaScope and the like. The reccomendationFilter includes an ACCL disallowed list. More specifically, the reccomendationFilter comprises at least one disallowed MOI. The at least one disallowed MOI refers to an MOI that the MDA consumer 102 is disallowed to access. For example, if an MOI is reserved for a particular entity, the MDA consumer 102 will not be allowed to access that particular disallowed MOI. As such, the ACCL disallowed list includes the at least one disallowed MOI and as such, the MDA producer 104 does not provide a recommendation including this at least one MOI. This ensures the performance of the MDA consumer 102 is not hindered by trying to execute recommendation on the at least one excluded MOI. Further, the startTime and the stopTime are based on observationTime defined in the assurance goal. The analyticsScope is based on the configuration of the MDA consumer 102. The analyticsScope is a DN of a NetworkSliceSubnet when an assurance goal comprises a sliceProfileId, the analyticsScope is a DN of a NetworkSlice when an assurance goal comprises a serviceProfileId and the analyticsScope is a DN of the NetworkSlice and the NetworkSliceSubnet when an assurance goal comprises the sliceProfileId and the serviceProfileId. The areaScope defines the area of interest of the MDA consumer 102. The areaScope defines a geographical location wherein the geographical location may be defined as one of Tracking Area Identity List (TaiList), a set of latitude and longitude or a civic address.

At 406, the MDA consumer 102 sends an MDARequest to the MDA producer 104. The MDARequest comprises the one or more attributes.

At 408, the MDA producer 104 identifies one or more allowed MOIs based on the one or more attributes. The one or more attributes comprises at least one disallowed MOI. In other words, the recommendationFilter specifies the at least one disallowed MOI. The MDA producer 104 identifies one or more allowed MOIs from a plurality of MOIs that can be included in the one or more recommendations. More specifically, the one or more allowed MOIs are the MOIs from the plurality of MOIs available except the at least one disallowed MOI. The one or more allowed MOIs are the MOIs that the MDA consumer 102 can modify and reconfigure.

At 410, the MDA producer 104 generates an analytic report based on the MDARequest. The analytic report may include one or more recommendations for the MDA consumer 102. However, the analytic report is not limited to one or more recommendations, it may include other information such as resource allocation, management of MOIs, improving performance and the like. In an example scenario, the resources initially allocated to the MDA consumer 102 are insufficient to facilitate load requirements of the MDA consumer 102. As such, the MDA consumer 102 may modify or reconfigure the one or more allowed MOIs based on the one or more recommendations. The one or more recommendations are provided in the analytic report to efficiently use the resources for managing the load requirements of the MDA consumer 102. This helps improve the performance of the MDA consumer 102 and improves the management of network resources.

In an embodiment, the one or more attributes comprise the recommendationFilter and the areaScope. The MDA producer 104 will identify the one or more allowed MOIS based on the recommendationFilter and the areaScope. The areaScope defines a geographical location wherein the geographical location may be defined as one of Tracking Area Identity List (TaiList), a set of latitude and longitude or a civic address. For example, if the areaScope is defined for a particular location XYZ, the MDA producer 104 will identify the one or more allowed MOIs in the XYZ location excluding the at least one disallowed MOI. The at least one disallowed MOI is defined in the recommendationFilter.

In an embodiment, the one or more attributes comprises the recommendationFilter and the analyticsScope. The MDA producer 104 will identify the one or more allowed MOIs based on the recommendationFilter and the analyticsScope. The analyticsScope defines the slice or slice subnet for which the MDA producer 104 should perform analytics. Further, the analyticsScope also defines the one or more parameters associated with that slice or service. For example, the one or more parameters may include, but are not limited to, throughput, energy requirements, traffic handling capabilities, load handling capabilities and the like. The information that is obtained by due to the analyticsScope, enables the MDA producer 104 to provide one or more recommendations optimally. For example, if the one or more parameters is traffic, the MDA producer 104 will provide recommendations to manage the traffic for a particular service or slice based on the analyticScope.

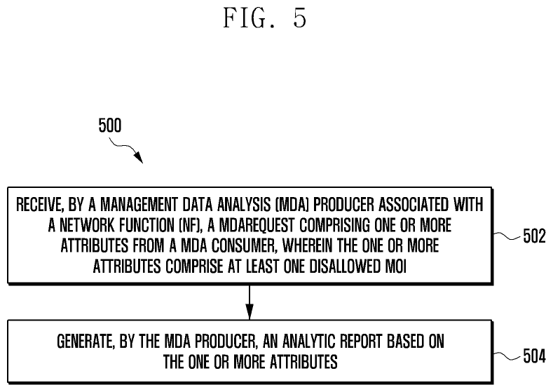

At 412, the analytic report comprising the one or more recommendations is sent to the MDA consumer 102 for execution. The MDA consumer 102 will decide which recommendation from the one or more recommendation can be applied to manage network resources. The decided recommendation is then applied by the MDA consumer 102. An example method for generating the analytic report is explained next with reference to FIG. 5.

FIG. 5 illustrates a flow chart of a method 500 for ACCL management, in accordance with an embodiment of the present disclosure. The method 500 depicted in the flow diagram may be executed by, for example, the MDA producer 104 (shown in FIGS. 1 and 2). Operations of the flow diagram, and combinations of operation in the flow diagram, may be implemented by, for example, hardware, firmware, a processor, circuitry and/or a different device associated with the execution of software that includes one or more computer program instructions. The operations of the method 500 are described herein with help of the MDA producer 104. The method 500 starts at operation 502

At operation 502 of the method 500, a MDARequest comprising one or more attributes is received from the MDA consumer 102 by a MDA producer 104 associated with a NF, such as the MDA producer 104 shown and explained with reference to FIGS. 2-4. In an embodiment, the one or more attributes comprise at least one disallowed Management Object Instance (MOI). The at least one disallowed MOI is included in the MDARequest as a recommendationFilter. Some examples of the one or more attributes may include, but not limited to, a recommendationFilter, a startTime, a stopTime, an areaScope and the like.

At operation 504 of the method 500, the MDA producer 104 generates an analytic report based on the one or more attributes. The analytic report includes one or more recommendations. Generating of the analytic report is explained in detail with reference to FIG. 4 and is not explained herein for the sake of brevity.

Referring now to FIG. 2, the analytics report can be stored in a database 210. The MDA producer 104 is depicted to be in operative communication with a database 210. In one embodiment, the database 210 is configured to store one or more analytic reports generated by the processor 202 over a period of time. Further, the database 210 may comprise one or more Artificial Intelligence (AI) models to generate the analytic report.

The database 220 may include multiple storage units such as hard disks and/or solid-state disks in a redundant array of inexpensive disks (RAID) configuration. In some embodiments, the database 220 may include a storage area network (SAN) and/or a network attached storage (NAS) system. In one embodiment, the database 220 may correspond to a distributed storage system, wherein individual databases are configured to store custom information, such as one or more MDARequest, one or more analytic reports and the like.

In some embodiments, the database 210 is integrated within the MDA producer 104. For example, the MDA producer 104 may include one or more hard disk drives as the database 210. In other embodiments, the database 210 is external to the MDA producer 104 and may be accessed by the MDA producer 104 using a storage interface (not shown in FIG. 2). The storage interface is any component capable of providing the processor 202 with access to the database 210. The storage interface may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 202 with access to the database 210.

The sequence of operations of the method 300, the method 400 and the method 500 need not be necessarily executed in the same order as they are presented. Further, one or more operations may be grouped together and performed in form of a single step, or one operation may have several sub-steps that may be performed in parallel or in sequential manner.

Various embodiments of the present disclosure provide numerous advantages. The present disclosure discloses the MDA producer 104 and a method to generate an analytic report. All recommendations included in the analytic report can be executed by a MDA consumer 102. The recommendations provided in the analytic report include one or more allowed MOI from a plurality of MOI. The one or more allowed MOI can be reconfigured and/or modified by the MDA consumer 102 as it excludes at least one disallowed MOI. This prevents the MDA consumer 102 from repeatedly re-questing for the analytic report including recommendations that can be executed by the MDA consumer 102. This improves the efficiency of the MDA producer 104. Further, it increases the performance of the MDA consumer 102 as it need not wait for the appropriate recommendation that can be executed thereby making the MDA consumer faster and robust.

The disclosed method with reference to FIG. 5, or one or more operations of the method 400 with reference to FIG. 4 may be implemented using software including computer-executable instructions stored on one or more computer-readable media (e.g., non-transitory computer-readable media, such as one or more optical media discs, volatile memory components (e.g., DRAM or SRAM), or non-volatile memory or storage components (e.g., hard drives or solid-state non-volatile memory components, such as Flash memory components) and executed on a computer (e.g., any suitable computer, such as a laptop computer, net book, Web book, tablet computing device, smart phone, or other mobile computing device). Such software may be executed, for example, on a single local computer.

The described operations may be implemented as a method, system or article of manufacture using standard programming and/or engineering techniques to produce software, firmware, hardware, or any combination thereof. The described operations may be implemented as code maintained in a “non-transitory computer readable medium”, where a processor may read and execute the code from the computer readable medium. The processor is at least one of a microprocessor and a processor capable of processing and executing the queries. A non-transitory computer readable medium may include media such as magnetic storage medium (e.g., hard disk drives, floppy disks, tape, etc.), optical storage (CD-ROMs, DVDs, optical disks, etc.), volatile and non-volatile memory devices (e.g., EEPROMs, ROMs, PROMs, RAMS, DRAMs, SRAMs, Flash Memory, firmware, programmable logic, etc.), etc. Further, non-transitory computer-readable media may include all computer-readable media except for a transitory. The code implementing the described operations may further be implemented in hardware logic (e.g., an integrated circuit chip, Programmable Gate Array (PGA), Application Specific Integrated Circuit (ASIC), etc.).

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items or meant to be limited to only the listed item or items. It must also be noted that as used herein, the singular forms “a,” “an,” and “the” include plural references unless the context clearly dictates otherwise.

Furthermore, one or more computer-readable storage media may be utilized in implementing embodiments consistent with the present disclosure. A computer readable storage medium refers to any type of physical memory on which information or data readable by a processor may be stored. Thus, a computer readable storage medium may store instructions for execution by one or more processors, including instructions for causing the processor(s) to perform steps or stages consistent with the embodiments described herein. The term “computer readable medium” should be understood to include tangible items and exclude carrier waves and transient signals, i.e., are non-transitory. Examples include random access memory (RAM), read-only memory (ROM), volatile memory, non-volatile memory, hard drives, CD ROMs, DVDs, flash drives, disks, and any other known physical storage media.

Finally, the language used in the specification has been principally selected for readability and instructional purposes, and it may not have been selected to delineate or circumscribe the inventive subject matter. Accordingly, the disclosure of the embodiments of the disclosure is intended to be illustrative, but not limiting, of the scope of the disclosure.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

1. A method performed by a management data analytics (MDA) consumer in a wireless communication system, the method comprising:
identifying a filter associated with a list of distinguished names (DNs) indicating at least one no recommendation should be given;
transmitting, to a MDA producer, a request message including the filter; and
receiving, from the MDA producer, as a response to the request message, a report message including at least one recommendation identified based on the filter.

2. The method of claim 1, wherein the request message further includes at least one of a starting time attribute, a stopping time attribute, or a scope associated with an analytics.

3. The method of claim 1, wherein the request message further includes at least one disallowed management object instance (MOI).

4. The method of claim 1, wherein the at least one of the starting time attribute, the stopping time attribute, or the scope associated with the analytics is determined based on an assurance goal.

5. A method performed by a management data analytics (MDA) producer in a wireless communication system, the method comprising:
receiving, from a MDA consumer, a request message including a filter associated with a list of distinguished names (DNs) indicating at least one no recommendation should be given;
identifying at least one recommendation based on the filter; and
transmitting, to the MDA producer, as a response to the request message, a report message including the at least one recommendation.

6. The method of claim 5, wherein the request message further includes at least one of a starting time attribute, a stopping time attribute, or a scope associated with an analytics.

7. The method of claim 6, wherein the request message further includes at least one disallowed management object instance (MOI).

8. The method of claim 6, wherein the at least one of the starting time attribute, the stopping time attribute, or the scope associated with the analytics is determined based on an assurance goal.

9. A management data analytics (MDA) consumer in a wireless communication system, comprising:
a transceiver; and
a controller coupled with the transceiver, the controller configured to:
identify a filter associated with a list of distinguished names (DNs) indicating at least one no recommendation should be given,
transmit, to a MDA producer, a request message including the filter, and
receive, from the MDA producer, as a response to the request message, a report message including at least one recommendation identified based on the filter.

10. The MDA consumer of claim 9, wherein the request message further includes at least one of a starting time attribute, a stopping time attribute, or a scope associated with an analytics.

11. The MDA consumer of claim 9, wherein the request message further includes at least one disallowed management object instance (MOI).

12. The MDA consumer of claim 9, wherein the at least one of the starting time attribute, the stopping time attribute, or the scope associated with the analytics is determined based on an assurance goal.

13. A management data analytics (MDA) producer in a wireless communication system, comprising:
a transceiver; and
a controller coupled with the transceiver, the controller configured to:
receive, from a MDA consumer, a request message including a filter associated with a list of distinguished names (DNs) indicating at least one no recommendation should be given,
identify at least one recommendation based on the filter, and
transmit, to the MDA consumer, as a response to the request message, a report message including the at least one recommendation.

14. The MDA producer of claim 13, wherein the request message further includes at least one of a starting time attribute, a stopping time attribute, or a scope associated with an analytics.

15. The MDA producer of claim 13, wherein the request message further includes at least one disallowed management object instance (MOI), and
wherein the at least one of the starting time attribute, the stopping time attribute, or the scope associated with the analytics is determined based on an assurance goal
